(19) United States
(12) Patent Application Publication
(10) Pub. No.: US 2011/0187610 A1
(43) Pub. Date: Aug. 4, 2011

(54) Antenna Device For A Radio Communication Device

(75) Inventors: Axel von Arbin, Taby (SE); Ulf Palin, Ljustero (SE); Per Erlandsson, STOCKHOLM (SE)

(73) Assignee: LAIRD TECHNOLOGIES AB, Kista (SE)

(21) Appl. No.: 13/019,230

(22) Filed: Feb. 1, 2011

(30) Foreign Application Priority Data
Feb. 2, 2010 (EP) 10152347.0

(51) Int. Cl. H01Q 1/22

(52) U.S. Cl. 343/702

(57) ABSTRACT

Exemplary embodiments are provided of antenna devices for portable radio communication devices. In an exemplary embodiment, an antenna device generally includes a metal cover. The metal cover generally includes a front side part, a first back side part connected to the front side part through a top side part, and a second back side part connected to the front side part through a bottom side part. The bottom and top side parts are positioned at opposite ends of the front side part. The first and second back side parts are distanced from each other by a slot. The first back side part comprises a feed point positioned at the slot and a ground point. The first back side part is fed through the feed point.

### CROSS REFERENCE TO RELATED APPLICATION

This patent application claims priority of European patent application No. EP10152347.0 filed Feb. 2, 2010. The disclosure of the application identified in this paragraph is incorporated herein by reference in its entirety.

### FIELD

The present disclosure relates generally to antenna devices for radio communication devices, and particularly to antenna devices for portable radio communication devices.

### BACKGROUND

This section provides background information related to the present disclosure which is not necessarily prior art.

A current trend for portable radio communication devices, such as mobile phones, persona digital assistants (PDAs), portable computers, and similar devices, is to provide the device with a metal cover. A metal cover for a portable radio communication device makes it difficult to provide the device with a non-protruding antenna, as the metal cover shields the inner of the device for radio frequencies. It is possible to only partly provide the cover as a metal cover, to allow the use of a built in antenna, but the inventors hereof have recognized that it would be desirable to provide a full metal cover.

Another trend for portable radio communication devices, such as mobile phones and similar devices, is to provide the device with a very broadband coverage, covering e.g. GSM850, GSM900, GSM1800, GSM1900, UMTS 2100 MHz, LTE, GPS, BT and WLAN 2.4 GHz. This puts further restrictions on the design of an antenna for a portable radio communication device.

### SUMMARY

This section provides a general summary of the disclosure, and is not a comprehensive disclosure of its full scope or all of its features.

According to various aspects, exemplary embodiments are disclosed of antenna devices for portable radio communication devices. In an exemplary embodiment, an antenna device generally includes a metal cover. The metal cover generally includes a front side part, a first back side part connected to the front side part through a top side part, and a second back side part connected to the front side part through a bottom side part. The bottom and top side parts are positioned at opposite ends of the front side part. The first and second back side parts are distanced from each other by a slot. The first back side part comprises a feed point positioned at the slot and a ground point. The first back side part is fed through the feed point.

Further features, advantages, and areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically shows a side elevation view of a metal cover for a mobile phone according to an exemplary embodiment of the present disclosure.

FIG. 2 schematically shows a back side view of a metal cover provided with feeding and grounding lines.

FIG. 3 schematically shows a front view of the metal cover shown in FIG. 2.

FIG. 4 schematically shows a variant of the metal cover shown in FIG. 1.

FIG. 5 schematically shows a ground connection between a front side part and a back side part of a metal cover for a mobile phone according to an exemplary embodiment of the present disclosure.

FIG. 6 shows a blown up portion of FIG. 5, more clearly illustrating oriented wires.

FIG. 7 schematically shows an alternative ground connection between a front side part and a back side part of a metal cover for a mobile phone according to another exemplary embodiment of the present disclosure.

FIG. 8 schematically shows yet an alternative ground connection between a front side part and a back side part of a metal cover for a mobile phone according to another exemplary embodiment of the present disclosure.

FIG. 9 schematically shows a touch screen connection cable connection positioned in a screening box.

FIG. 10 shows a blown up portion of FIG. 9.

FIG. 11 schematically shows a metal cover without a cavity for a battery.

FIG. 12 schematically shows a metal cover with a cavity for partial accommodation of a battery.

FIG. 13 schematically shows a slider phone.

FIG. 14 schematically shows an alternative slider phone.

FIG. 15 schematically shows alternative positions for feed points.

FIG. 16 schematically shows more alternative positions for feed points.

FIG. 17 schematically shows positioning of a battery spread out over both the high band portion as well as the low band portion.

FIG. 18 schematically shows front cover adjustment for partial accommodation of a battery.

FIG. 19 schematically shows practical available space for metallic features inside the metal cover.

FIG. 20 schematically shows mathematical available space for metallic features inside the metal cover.

FIG. 21 schematically shows material size of a metal corner of a metal cover for a mobile phone.

FIG. 22 shows a matching net for a common feed point of the antenna device.

FIG. 23 schematically shows a back side of a metal casing for a mobile phone according to a second embodiment of the present disclosure.

FIG. 24 schematically shows a back side of a metal casing for a mobile phone according to a third embodiment of the present disclosure.

FIG. 25 schematically shows a side view of a metal casing for a mobile phone according to a fourth embodiment of the present disclosure.

FIG. 26 schematically shows a side view of a metal casing for a mobile phone according to a fifth embodiment of the present disclosure.

FIG. 27 schematically shows a side view of a metal casing for a mobile phone according to a sixth embodiment of the present disclosure.

FIG. 28 schematically shows a back side and a side view of a metal casing for a mobile phone according to a seventh embodiment of the present disclosure.

### DETAILED DESCRIPTION

Example embodiments will now be described more fully with reference to the accompanying drawings.

Disclosed herein are exemplary embodiments of antenna devices for portable radio communication devices having metal covers. Also, disclosed herein are exemplary embodiments of portable radio communication devices, such as mobile phones, that include such antenna devices.

In an exemplary embodiment, an antenna device for a portable radio communication device is provided. The antenna device includes a metal cover. The metal cover includes a front side part, a first back side part connected to the front side part through a top side part, and a second back side part connected to the front side part through a bottom side part. The bottom and top side parts are positioned at opposite ends of the front side part. The first and second back side parts are distanced from each other by a slot. The first back side part comprises a feed point at the slot and a ground point. The first back side part is fed through the feed point such that a broad band antenna having a directed radiation pattern can be provided.

Continuing with a description of this exemplary embodiment, the feed point is preferably positioned near the middle of the slot to facilitate providing the broad frequency band. The ground point is further preferably positioned near a corner of the top side part, to tune the frequency band coverage. The second back side part preferably comprises a feed point at the slot.

For changed visual appearance of the portable radio communication device, the metal cover may preferably be arranged on the inside of a visual coating of the portable radio communication device. Available space inside the antenna device may advantageously comprise an audio resonant cavity within the metal cover, preferably two audibly equivalent resonant cavities for providing stereo sound.

Due to the configuration of the antenna device in this exemplary embodiment, the front side part can preferably be provided with four metal corners connected to the first and second back side parts, respectively, at least covering 2 millimeters (mm) on the side edge and top and bottom side parts, respectively. This provides improved wear resistance.

Electrical connection between the first back side part and the front side part through the top side part preferably includes a plurality of conductive connectors for well defined grounding of the first back side part. Electrical connection between the second back side part and the front side part through the bottom side part preferably includes a plurality of conductive connectors for well defined grounding of the second back side part.

Advantageously, the front side part and at least a major portion of the top and bottom side parts are made of forged metal. And, the first and second back side parts are preferably made of stamped metal. Alternatively, other materials may be used in other embodiments.

By way of example, antenna efficiency may be improved by using stamped metal that is at least partly with an oxidation and/or wear resistant conductor such as copper, silver, titanium, gold, or an alloy thereof. To improve RF screening and utilization of available space, for example, the front side part preferably comprises a printed wiring board arranged in an opening in the front side part, and wherein the printed wiring board is RF sealed to the front side part, preferably by means of a conductive gasket.

For an efficient way of screening a display having a RF unshielded cable, the antenna device may include a printed wiring board positioned over an opening in the front side part. And, the antenna device may include a conductive gasket arranged between the printed wiring board and the front side part to electromagnetically screen the RF unshielded cable from the first and second back side parts.

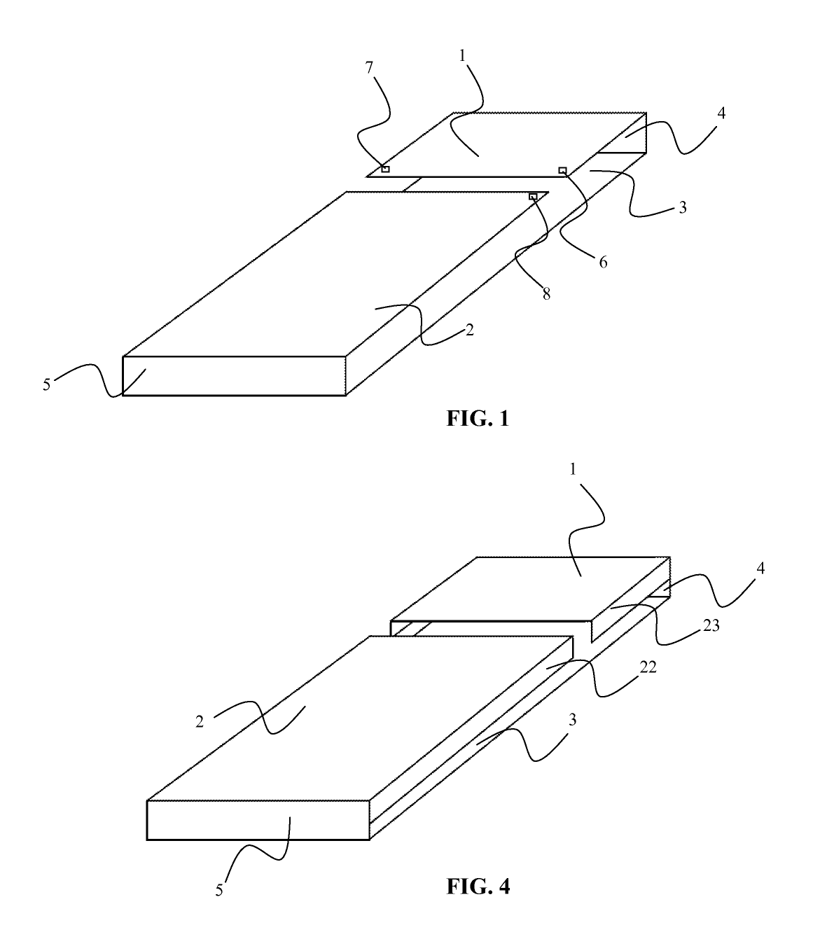

With reference now to the figures, FIGS. 1-3 illustrate an antenna device for a portable radio communication device according to a first embodiment of the present disclosure. In this exemplary embodiment, the antenna device includes a metal cover for the portable radio communication device, here described as a mobile phone.

As shown in FIGS. 1-3, the back side of the metal cover, arranged in the back side of the mobile phone, is divided into two parts. A first back side part 1 is connected to the front side part 3 of the metal cover through a top side part 4. A second back side part 2 is connected to the front side part 3 of the metal cover through a bottom side part 5. The first back side part 1 and the second back side part 2 are essentially coplanar and distanced from each other by a slot of about 2 mm to 5 mm, preferably 3 mm. The first and second back side parts should be coplanar at least along the slot, through which they interact with each other.

The first back side part 1 is driven as a multi-band antenna element by being fed at a feed point 6 (FIG. 1) at a corner near the slot against the second back side part 2, by being grounded at a ground point 7 at an opposite corner near the slot against the second back side part 2, and by being grounded along the top side part 4. For a mobile phone, and thus its metal cover, having a length of about 110 mm, a width of about 65 mm, and a thickness of about 5 mm, a frequency band coverage of about 1550 Megahertz (MHz) to 2500 MHz is achievable. The first back side part 1 has a generally rectangular shape having a length of about 35 mm and a width of about 65 mm, in this example.

The second back side part 2 is driven as an antenna element by being fed at a feed point 8 at a corner near the slot against the first back side part 1, and by being grounded along the bottom side part 5. For a mobile phone, and thus its metal cover, having a length of about 110 mm, a width of about 65 mm, and a thickness of about 5 mm, a frequency band coverage of about 750 MHz to 1050 MHz is achievable. The second back side part 2 has a generally rectangular shape having a length of about 72 mm and a width of about 65 mm, in this example.

The first back side part 1 and second back side part 2 are functioning as radiating elements over a ground plane, i.e. over the front side part 3 in this example. For a portable radio communication device, a very broad band antenna having a much directed radiation pattern, directed from the front side part backwards through the slot, is achieved by having the first and second back side parts, respectively, connected to the front side part through the top and bottom grounding means, wherein the front side part is a large ground plane. A combination of the length and width of the second back side part provides for the bandwidth of the low-band operation. If the length or width is increased, the lowest frequency of the low-band operation is reduced. And, if the length or width is decreased, the lowest frequency of the low-band operation is increased. If the width of the slot is reduced, the high-band operation is tuned down. And, if the length of the slot is reduced, the high-band operation is tuned up. If the length of the first back side part is reduced, the high-band operation is tuned up.

The slot is illustrated as a straight slot between two planar parts. The slot and the two planar parts can, however, have different shapes, such as being slightly curved in the length direction and/or in the width direction. Also, the slot need not be completely straight, but can comprise variations along its length, as long as the width of the slot is kept essentially constant.

A display device and/or a key pad are typically provided with grounded shielding means, through the front side part. The grounded shielding means then form part of the front side part. Further, in a mobile phone e.g. having a touch screen occupying essentially the whole front thereof, the front side part of the metal cover will then be made up by the shielding means of the touch screen.

The first and second back side parts have been described as having feed points 6 and 8, respectively. Feeding of the feed points 6 and 8 is advantageously provided as two separate feedings 11 and 10 (FIG. 3) through two separate ports to RF circuitry, to improve isolation there between. But the feeding of the feed points 6 and 8 could alternatively be provided through a common port having filtering means to separate signaling to and from RF circuitry. The ground point 7 is fed through feeding 9 (FIG. 2).

The second back side part 2 preferably covers the whole battery of the mobile phone. The second back side part is preferably pivotable around and/or detachably attached to the bottom side part to facilitate access into the mobile phone for e.g. changing battery or for changing a subscriber identity module (SIM) card of the mobile phone.

For improved antenna function, the metal cover is preferably made up by or metalized by a good electrically-conductive material. The front side part and major portions of the top side and bottom side parts are preferably manufactured as an integral forged metal part. The forged metal is e.g. made up by an aluminum alloy, stainless steel, nickel/brass, magnesium, etc. The back side parts are preferably manufactured by a stamped sheet metal, e.g. an aluminum alloy, possible coated (typically 3-5 micrometers (μm)) with an oxidation and wear resistant conductor such as e.g. copper, silver, gold, titanium or alloys thereof. Such a coating can also be used as masking when an anodizing process is performed for e.g. coloring and/or surface finish treatment of the metal. The materials listed in this paragraph (as are all materials listed herein) are for purpose of illustration only as other embodiments may be formed from different materials.

For other appearances of the mobile phone, such as a plastic, wood or leather appearance, the inside of such a outer contour can be coated on the inside with metallization through e.g. PVD, electro less plating, adhesive, forging painting, spraying, or laminating. By stacking materials with different properties and characteristics, such as high dielectric materials, low loss materials, high conductive materials, RF transparent materials, optically transparent materials, high wear resistance and good corrosion resistance, certain parameters can be optimized and thereby enhance the performance. The stacked materials can either cover the entire area or be made selectively. One example could be to add a layer of a low loss material between the radiating structure and the mechanical carrier in order to enhance the antenna performance. With such a solution, it is possible to add additional antenna radiators in non-sensitive areas of the first and second back side parts, e.g., near well grounded areas such as near the top and bottom side parts.

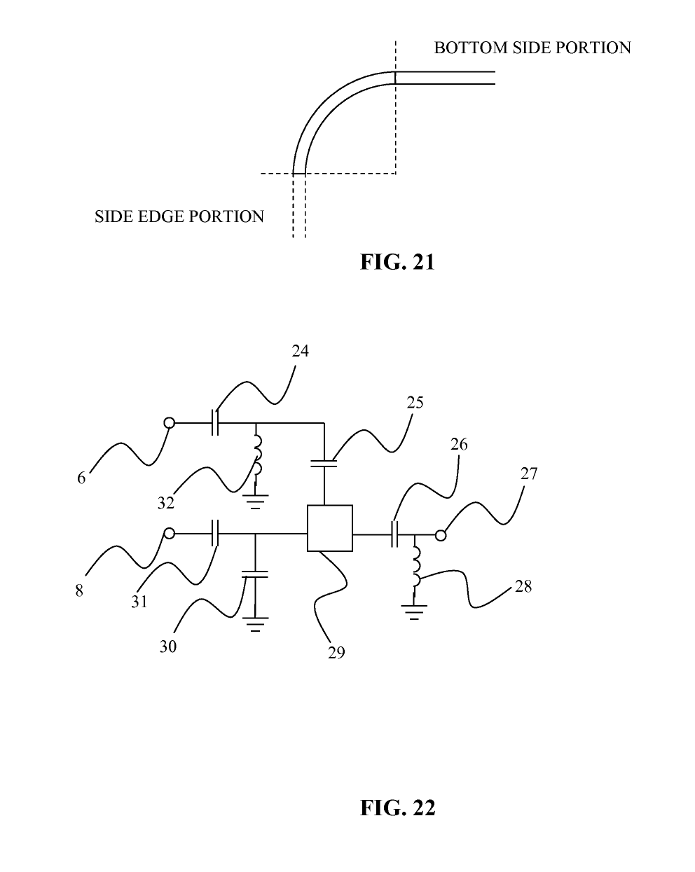

The corners of the metal cover are preferably rounded between the top side part and the side edge parts, as well as between the bottom side part and the side edge parts. The forged front side part can be designed with different material thickness at different areas and thereby be optimized from mechanical robustness, cost, and weight/volume perspective. More material in corners that are subjected to higher mechanical impact and wearing gives a more robust and less sensitive product. The shape of an exemplary corner is illustrated in FIG. 21. The thickness of the material is today limited to be at least 0.3 mm when being forged, but preferably has a thickness of about 0.8 mm for structural strength and wear resistance. By providing the whole curvature of the corner in forged metal, the most wear exposed parts of a mobile phone is provided with a very wear resistant metal part. This facilitates design of mobile phones having very thin forms.

The parts of the antenna device not of metal, such as e.g. the slot and side edges, can be provided with plastic or other RF transparent material. These areas can be made visually looking like metal by using a RF transparent PVD coating technique, applying a layer of about 0.1 to 1 nanometer (nm) metal. Such a layer is typically protected by a layer of varnish. Also, the metallic parts of the antenna device are typically protected by a layer of varnish and/or is treated to prevent oxidization thereof.

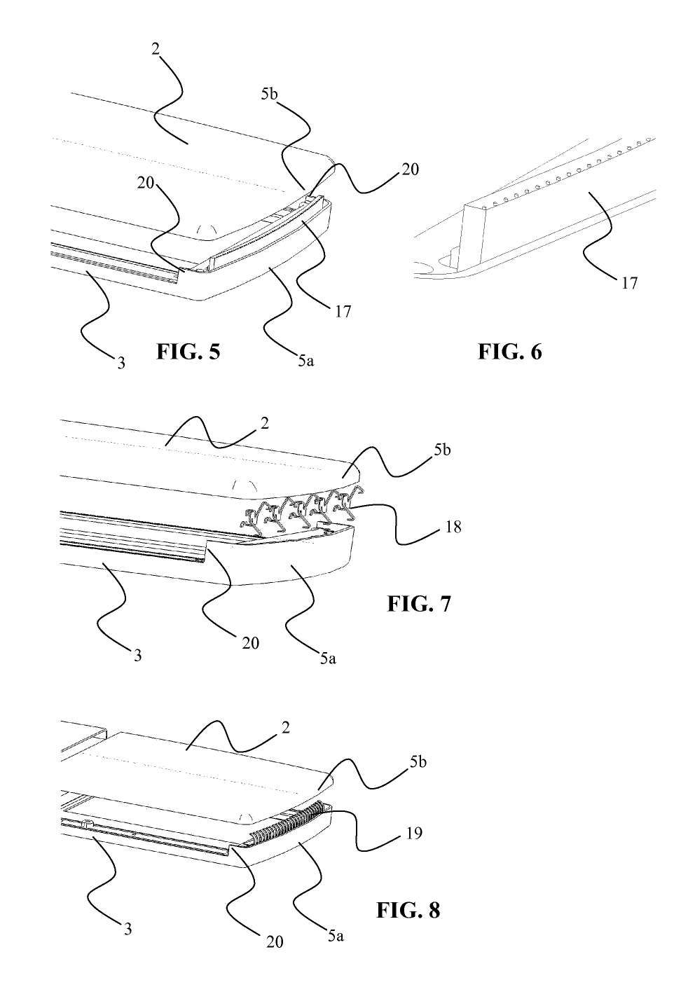

The top and bottom side parts have been illustrated as parts electrically covering the top and bottom side, respectively, of the portable radio communication device, but can alternatively comprise a plurality of grounding portions together not completely electrically covering the top or bottom side, respectively. Such connections can, for example, be provided by means of spring loaded connectors. The electrical coverage of the top and bottom sides are preferably dense, to prevent too much leakage of RF energy causing antenna efficiency loss. Alternative solutions are illustrated in FIGS. 5 through 8.

FIG. 5 illustrates how a contact means 17, in this case a conductive gasket, preferably an oriented wire gasket, is used to provide electrical connection between the second back side part 2 and the front side part 3. As shown, the bottom side part 5 is divided in parts 5a and 5b, such that both the second back side part as well as the front side part comprise bent edges, to improve their structural rigidity. In FIG. 6 the contact means 17 of FIG. 5 is illustrated blown up, to show the oriented conductive wires in an oriented wire gasket. In case the contact means 17 does not provide electrical connection around the corners of the metal cover, additional contact means such as e.g. spring loaded connectors are arranged at the outer end of the corners 20 to provide well defined grounding positions. For a well defined ending of the corners, the grounding should be provided until the beginning of the opening at the side edge of the metal cover. A similar connection means can also be provided at the top side part of the metal cover.

FIG. 7 illustrates how the contact means 18, in this case a plurality of contact clips are used to provide electrical connection between the second back side part 2 and the front side part 3. As shown, the bottom side part 5 is divided in parts 5a and 5b, such that both the second back side part as well as the front side part comprise bent edges, to improve their structural rigidity. In case the contact means 17 does not provide electrical connection around the corners of the metal cover, additional contact means such as e.g. spring loaded connectors are arranged at the outer end of the corners 20 to provide well defined grounding positions. For a well defined ending of the corners, the grounding should be provided until the beginning of the opening at the side edge of the metal cover. A similar connection means can also be provided at the top side part of the metal cover.

FIG. 8 illustrates how the contact means 19, in this case an integrated spring leaf is used to provide electrical connection between the second back side part 2 and the front side part 3. As shown, the bottom side part 5 is divided in parts 5a and 5b, such that both the second back side part as well as the front side parts comprise bent edges, to improve their structural rigidity. In case the contact means 17 does not provide electrical connection around the corners of the metal cover, additional contact means such as e.g. spring loaded connectors are arranged at the outer end of the corners 20 to provide well defined grounding positions. For a well defined ending of the corners, the grounding should be provided until the beginning of the opening at the side edge of the metal cover. A similar connection means can also be provided at the top side part of the metal cover.

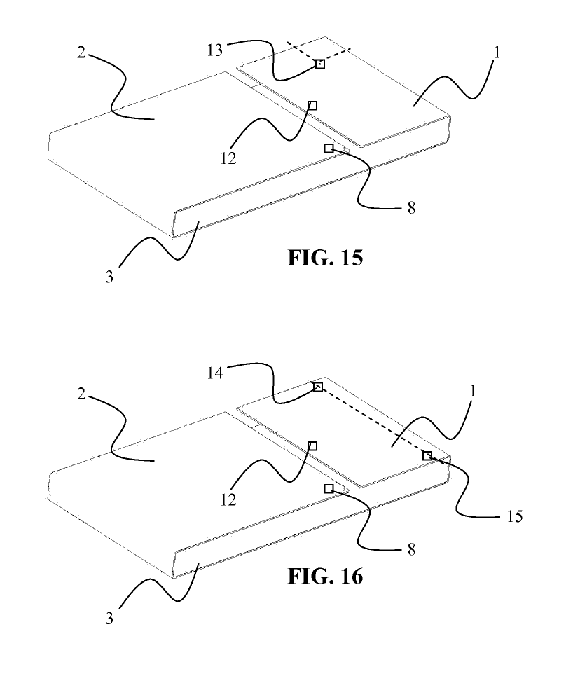

For tuning of the antenna device made up by the metal cover, additional grounding points can be added at the sides of the portable radio communication device. But tuning of the antenna device is preferably provided by selecting alternative positions for the feed and ground points, which is illustrated in FIGS. 15 and 16.

For example, the first back side part 1, being fed as the high-band part of the antenna device, preferably has the feed point 12 positioned close to the middle of the slot between the first back side part and the second back side part, about 30 mm from the side edge of the metal cover of its 65 mm width. The ground point 13, additional to the grounding at the top edge of the metal cover, of the high-band part of antenna device preferably is positioned a little distance from the grounded corner, as illustrated in FIG. 15. In this way the area marked by dashed lines is very well grounded and the corresponding volume of the antenna device can be utilized for essentially any other purpose than antenna function without disturbing the desired antenna function of the antenna device. By selecting the feed point 12 position close to the middle of the slot, low-band overtones from the second back side part is cut away and the coupling between the low band and high band is reduced.

In the alternative embodiment shown in FIG. 16, the first back side part 1, being fed as the high-band part of the antenna device, preferably has the feed point 12 positioned close to the middle of the slot between the first back side part and the second back side part, about 30 mm from the side edge of the metal cover of its 65 mm width. Two additional ground points 14 and 15, of the high-band part of antenna device, is preferably positioned along the sides of the first back side parts a little distance from the grounded corners, as illustrated in FIG. 16. In this way, the area marked by the dashed line is very well grounded and the corresponding volume of the antenna device can be utilized for essentially any other purpose than antenna function without disturbing the desired antenna function of the antenna device, such as e.g. a rounded or elliptical shape of the top side of the mobile phone. Further, electrical length of the first back side part is shortened, which can be utilized for tuning of the antenna device.

An exemplary matching net for two feed points 6 and 8 connected through a common port is illustrated in FIG. 22. Capacitor 24 has a capacitance of about 1 Pico Farad (pF), capacitor 25 has a capacitance of about 100 pF, capacitor 26 has a capacitance of about 100 pF, capacitor 30 has a capacitance of about 1 pF, capacitor 31 has a capacitance of about 2 pF, inductor 28 has an inductance of about 12 nanoHenries (nH), and inductor 28 has an inductance of about 10 nH. Switch 29 selects between connecting feed point 8 or feed point 6 to common RF port 27. It is also possible to exchange the switch with a diplex filter.

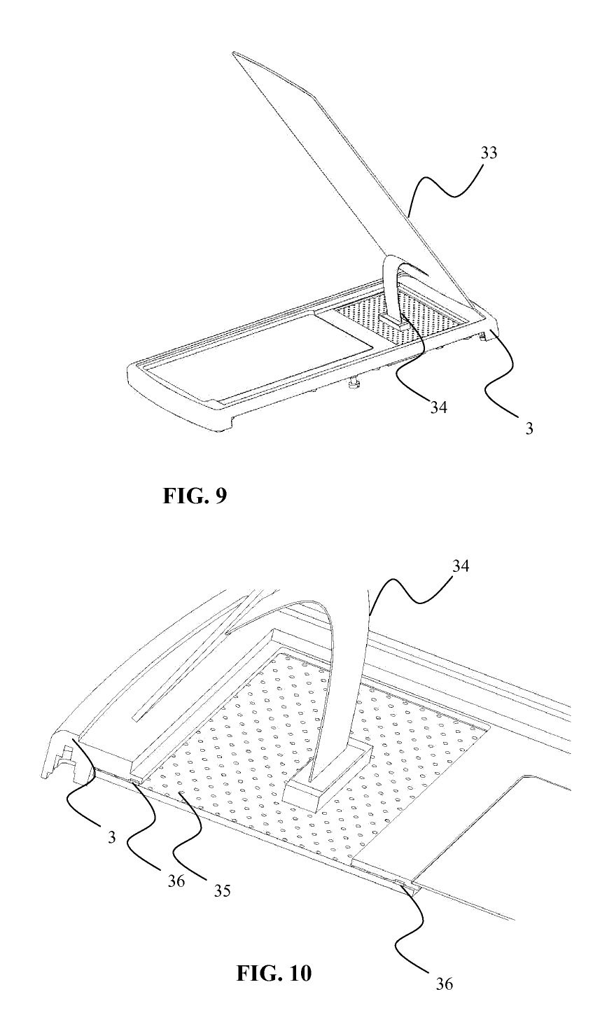

The front side part 3 of the antenna device is preferably provided with a printed wiring board 35 (PWB), e.g. the main PWB of the mobile phone, which is illustrated in FIGS. 9 and 10. Generally, a FPC 34 (Flexible Printed Circuit) and LIF/ZIF connectors are used for connecting the display 33 to the PWB. One problem is that the current flowing on the FPC often disturbs electronic components, particularly the RF circuitry. To efficiently electromagnetically screen the FPC from e.g. the RF circuitry, a conductive gasket 36 is arranged between the front cover 36 (around opening) and PWB 35 in this example for preventing RF leakage to the opposite side where the main parts of the components are located.

The inner volume of the antenna device between the first and second back side parts, the front side part, the top side part and the bottom side part may be utilized for different things. For non-metallic, or at least for non-conductive materials, essentially any part of the inner volume can be utilized. For conductive materials that may affect the antenna function, certain parts of the inner volume is not available for utilization. In some embodiments, the antenna device will require a spacing of about 2 mm from the second back side part to a high-performance battery, typically requiring a height of about 5 mm, for a mobile phone, and it can today typically not be provided in the inner volume below the second back side part 68×65×5 mm3, with the available space of 68×65×3 mm3. But due to the form of the exemplary antenna device shown in FIG. 17, it should be possible to accommodate a high-performance battery for a mobile phone spread out over essentially the whole front side part, in such a case requiring a height 32 of about 2 mm. Such a spread out battery can utilize a volume of 110×65×2 mm3.

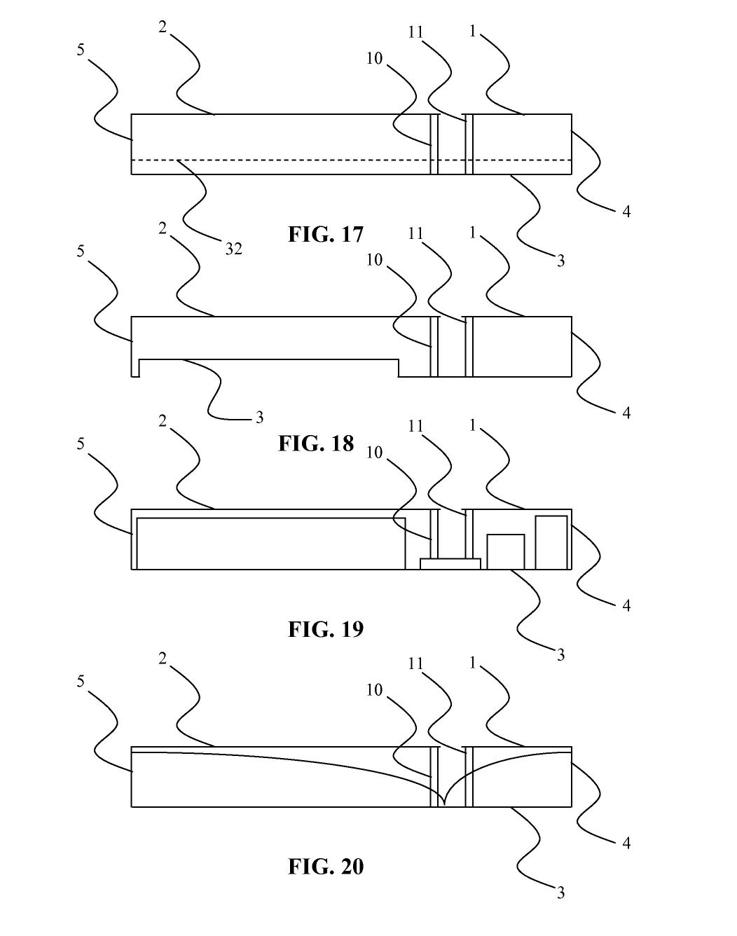

To utilize available space below the second back side part, the front side part 3 may preferably be profiled to reduce that space, as illustrated in FIG. 18.

Generally, the available inner volume of the antenna device can be divided into different areas allowing more or less available volume, which is illustrated in FIG. 18. Below the second back side part or low-band part, a distance of about 2 mm is required for adequate antenna performance in this example embodiment. Below the slot, a distance of about 5 mm is required for adequate antenna performance, essentially leaving no available volume there and preferably also near the slot. Also in this example, the portion of the first back side part nearest the slot a distance of about 3 mm is required for adequate antenna performance. The portion of the first back side part nearest the top side part a distance of about 1 mm is required for adequate antenna performance. A more mathematical description of available space is illustrated in FIG. 20.

The available inner volume, or parts thereof, can advantageously be utilized for audio purposes, since resonance cavities need not be made electrically conductive. The inner volume is large enough for providing very deep resonances, regarding mobile phones. But advantageously, two similar volumes are preferably provided to be able to provide stereo speakers with similar characteristics.

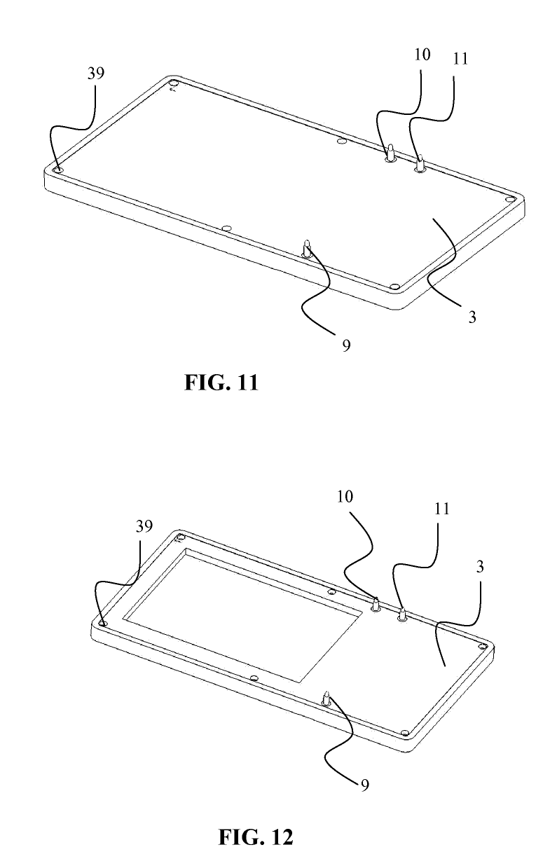

Due to the design of the antenna device in exemplary embodiments disclosed herein, the antenna device may advantageously be used as an antenna module attachable to a plurality of different mobile phone models. By being very broad banded, having a very directed radiation pattern directed away from the front side part through the slot, and being very well screened through the front side part, the antenna device is very little affected if attached to the front side part, facing away from the back side. Further, by making the front side part from forged metal, its form will be flexible in terms of e.g. differential height and it will have good structural strength. The antenna module is preferably attached to a mobile phone through screw fastening or snap fitting. For example, FIG. 11 illustrates a metal cover comprising antenna function, contact means 9-11, ground plane means 3, and details 39 for fastening the antenna module to a mobile phone module. In FIG. 12, a similar antenna module is illustrated, wherein the ground plane means 3 is shaped having a cavity for receiving a battery, at least partly.

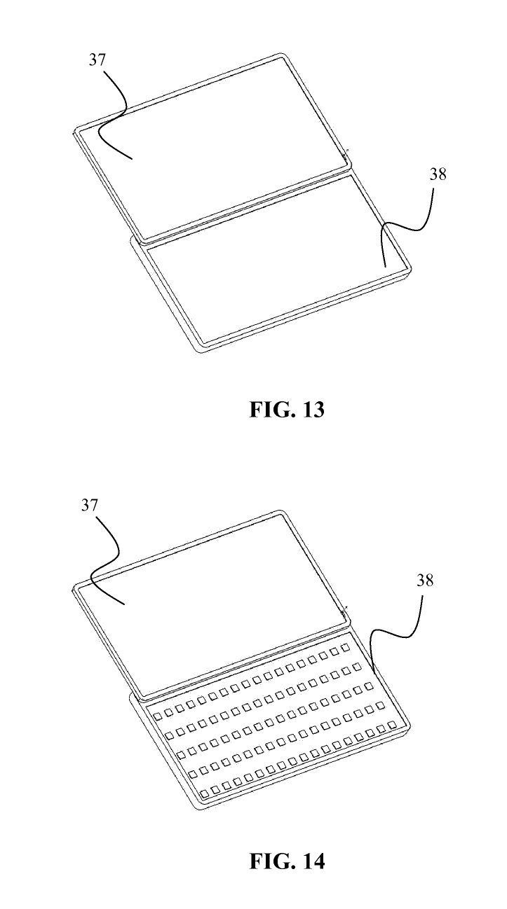

Advantageously, the module may be provided with sliding means on the front side part, which makes it possible to attach the antenna device to a slider mobile phone in which the revealable part 38 of the slider phone is partly accommodated in the front side part of the antenna module, and the front 37 of the slider phone is facing away from the antenna device. Such an exemplary slider phone is illustrated in FIG. 13 having a touch screen display in both outer facing parts 37 and 38. Another such exemplary slider phone is illustrated in FIG. 14 having a tough screen display in the outmost part 38 and a QWERTY board in the revealed part 38.

Although the first back side part has been described as generating the high frequency band and the second back side part has been describe as generating the low frequency band, the opposite is also possible. Also, either the first or the second back side part could generate both low and high frequency bands.

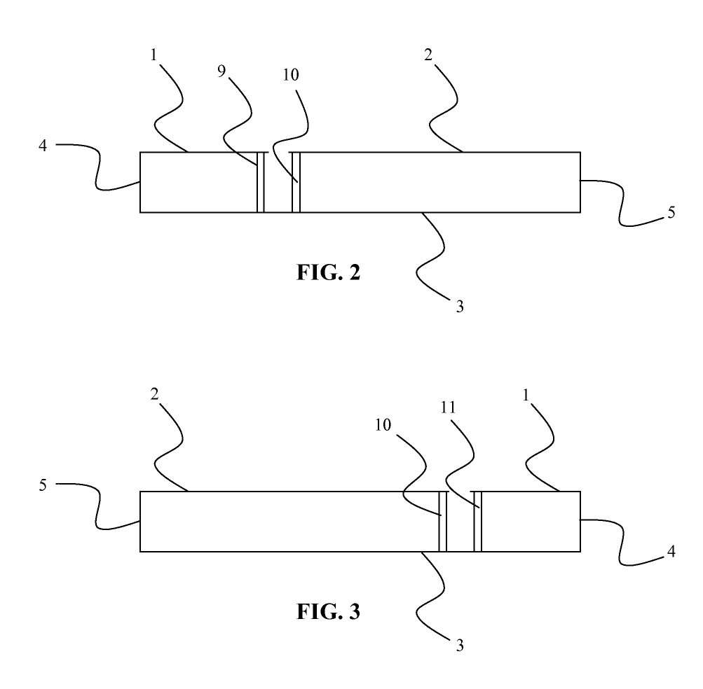

Additional tuning of the antenna device will be described with reference to FIG. 4. In this illustrated embodiment, the first back side part 1 and the second back side part 2 comprise respective folded side edge portions 23 and 22 extending towards the front side part, extending about 3 mm and thus leaving a slot of about 2 mm to the front side part 3. Although the folded side edge portions have been illustrated as extending along the whole first and second back side parts, it is also possible to only have portions of the first and second back side part edges folded towards the front side part.

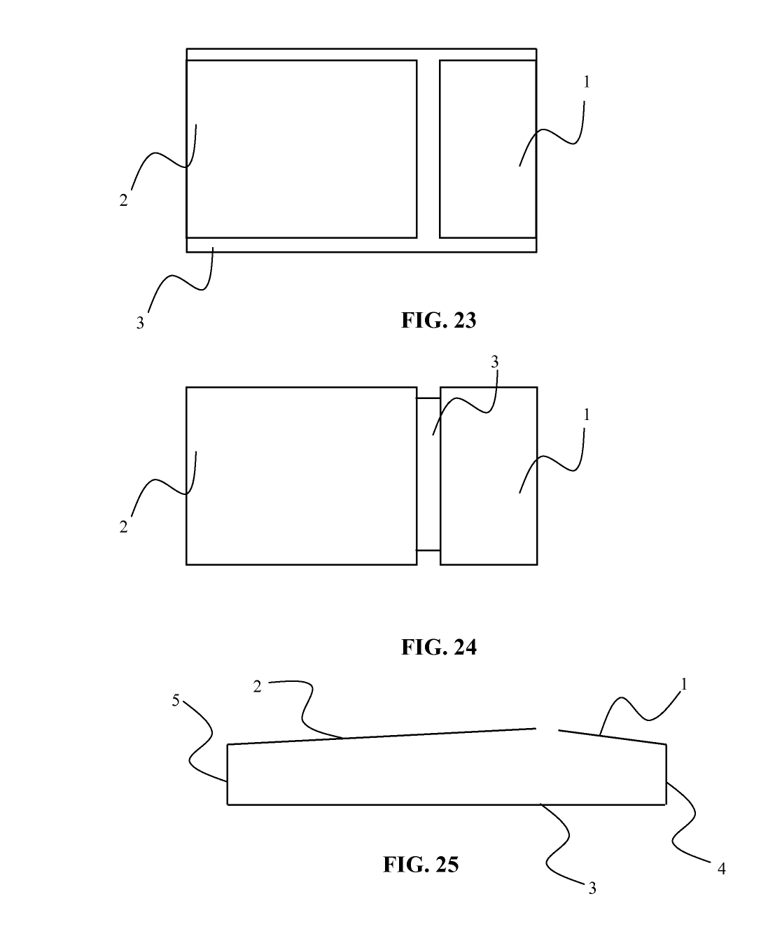

An antenna device or arrangement according to a second embodiment of the present disclosure will next be described with reference to FIG. 23. This second embodiment of the present disclosure is similar to the first embodiment described above apart from that the front side part 3 edges are folded towards the back side parts, and the first 1 and second 2 back side parts have a smaller extension than the front side part. The form of the gap is thus H-shaped in the back piece of the portable radio communication device.

An antenna device or arrangement according to a third embodiment of the present disclosure will next be described with reference to FIG. 24 This third embodiment of the present disclosure is similar to the first embodiment described above apart from that the front side part 3 has a smaller extension than the back side parts 1 and 2, and the frequency band coverage of the antenna elements are thus increased by the antenna elements being partly off-ground.

An antenna device or arrangement according to a fourth embodiment of the present disclosure will next be described with reference to FIG. 25 This fourth embodiment of the present disclosure is similar to the first embodiment described above apart from that the first and second back side parts 1 and 2 are non-coplanar. The distance between the back side parts and the front side part 3 are greatest at the gap and smallest at the top and bottom side parts 4, 5. In this way, the portable radio communication device can be adapted to rounded edges, thus allowing lower thickness in the outer portions of the portable radio communication device.

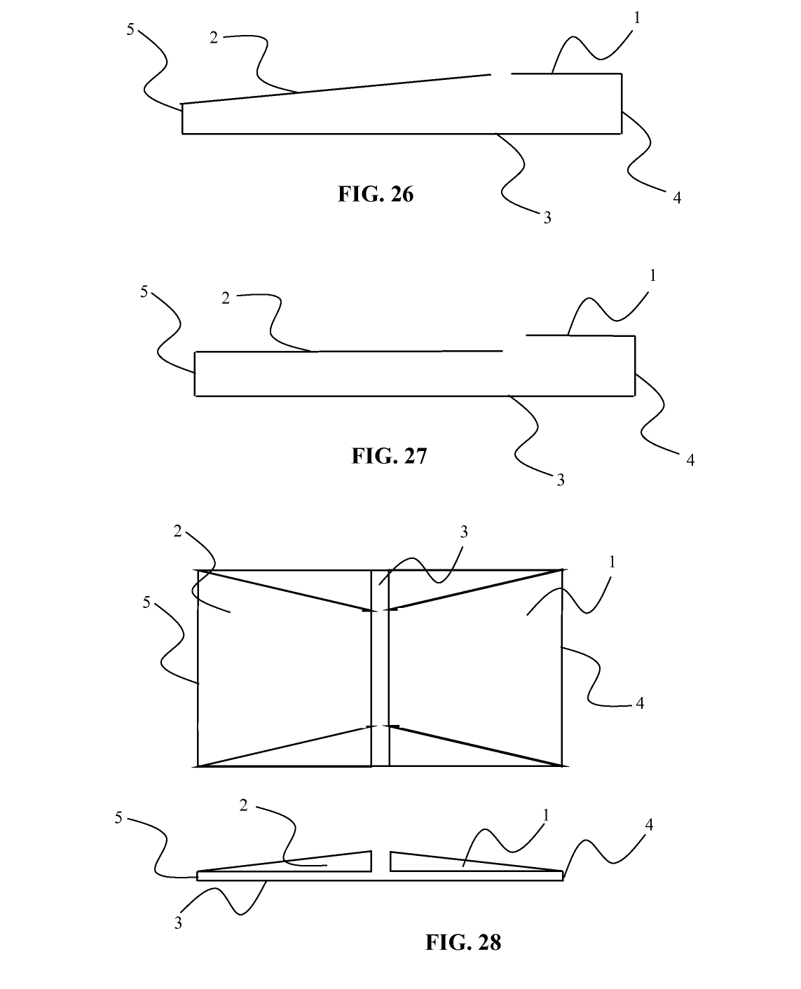

An antenna device or arrangement according to a fifth embodiment of the present disclosure will next be described with reference to FIG. 26 This fifth embodiment of the present disclosure is similar to the fourth embodiment described above apart from the first back side part 1 is planar and parallel to the front side part 3 and the second back side part 2 is tapered towards the bottom side part 5. In this way, the portable radio communication device can e.g. be adapted to rounded edges, thus allowing lower thickness in the outer portions of the portable radio communication device.

An antenna device or arrangement according to a sixth embodiment of the present disclosure will next be described with reference to FIG. 27. This sixth embodiment of the present disclosure is similar to the first embodiment described above apart from that the distance between the second back side part 2 and the front side part 3 is smaller than the distance between the first back side part 1 and the front side part. In this way, the portable radio communication device can e.g. be adapted to different volume requirements for different parts of the portable radio communication device.

An antenna device or arrangement according to a seventh embodiment of the present disclosure will next be described with reference to FIG. 28. This seventh embodiment of the present disclosure is similar to the fifth embodiment described above apart from that the first and second back side parts 1, 2 are tapered both towards the top and bottom side parts 4, 5, as well as towards the side edge parts. This further facilitates thinner portable radio communication devices, as well as rounded edges all around the portable radio communication device.

Numerical dimensions and values are provided herein for illustrative purposes only. The particular dimensions and values provided are not intended to limit the scope of the present disclosure.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. The disclosure of a first value and a second value for a given parameter can be interpreted as disclosing that any value between the first and second values could also be employed for the given parameter. Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. An antenna device for a portable radio communication device, the antenna device comprising a metal cover, the metal cover comprising:
a front side part;
a first back side part connected to the front side part through a top side part;
a second back side part connected to the front side part through a bottom side part;
wherein:
the bottom and top side parts are positioned at opposite ends of the front side part;
the first and second back side parts are distanced from each other by a slot;
the first back side part comprises a feed point positioned at the slot and a ground point; and
the first back side part is fed through the feed point.

2. The antenna device according to claim 1, wherein the second back side part comprises feed point positioned at the slot and is fed through the feed point on the second back side part.

3. The antenna device according to claim 1, wherein the first and second back side parts are positioned essentially coplanar.

4. The antenna device according to claim 1, wherein the feed point on the first back side part is positioned near the middle of the slot.

5. The antenna device according to claim 1, wherein the metal cover is arranged on the inside of a visual coating of the portable radio communication device.

6. The antenna device according to claim 1, comprising an audio resonant cavity within the metal cover.

7. The antenna device according to claim 6, wherein the audio resonant cavity comprises two audibly equivalent resonant cavities

8. The antenna device according to claim 1, wherein the front side part comprises four metal corners connected to the first and second back side parts, respectively, at least covering 2 millimeters n the side edge and top and bottom side parts, respectively.

9. The antenna device according to claim 1, wherein the top side part comprises a plurality of conductive connectors electrically connecting the first back side part and the front side part.

10. The antenna device according to claim 1, wherein the bottom side part comprises a plurality of conductive connectors electrically connecting the second back side part and the front side part.

11. The antenna device according to claim 1, wherein the front side part and at least a major portion of the top and bottom side parts are made of forged metal.

12. The antenna device according to claim 11, wherein the first and second back side parts are made of stamped metal.

13. The antenna device according to claim 12, wherein the stamped metal at least partly is coated with an oxidation and/or wear resistant conductor.

14. The antenna device according to claim 1, wherein:
the front side part comprises a printed wiring board arranged in an opening in the front side part; and
the printed wiring board is RF sealed to the front side part.

15. The antenna device according to claim 1, wherein:
the portable radio communication device comprises a display having a RF unshielded cable; and
the antenna device comprises a printed wiring board positioned over an opening in the front side part, and a conductive gasket arranged between the printed wiring board and the front side part to electromagnetically screen the RF unshielded cable from the first and second back side parts.

16. The antenna device according to claim 1 wherein the ground point is positioned near a corner of the top side part.

17. The antenna device according to claim 1, wherein the first and second back side parts have gap edge profiles that are mirrored to each other.

18. The antenna device according to claim 1, wherein the first and/or the second back side parts protrude outside of the front side part.

19. A portable radio communication device comprising an antenna device according to claim 1.
